(19) United States
(12) Patent Application Publication
(10) Pub. No.: US 2025/0163946 A1
(43) Pub. Date: May 22, 2025

(54) Snap-fit joint for interlocking cards and apparatuses formed thereby.

(71) Applicants: Bernard Ross, Long Beach, CA (US); Sherry Sindo, Long Becah, CA (US)

(72) Inventors: Bernard Ross, Long Beach, CA (US); Sherry Sindo, Long Becah, CA (US)

(21) Appl. No.: 18/432,072

(22) Filed: Feb. 5, 2024

Related U.S. Application Data
(60) Provisional application No. 63/443,438, filed on Feb. 5, 2023.

(51) Int. Cl. F16B 5/06; F16M 11/24

(52) U.S. Cl. CPC F16B 5/0614; F16M 11/24

(57) ABSTRACT

A snap-fit joint for monolithic card elements comprises plastic male and female members. Each monolithic snap-fit joint flexible card body for connecting at least a first and second snap-fit joint card body members, includes one of a vertically downward orientated slot, a vertically upward orientated slot, having left and right walls on one or both distal ends of the card body with at least one male member tab within the slot and protruding from at least one wall, correspondingly spaced female member hole separate from the slot along the same vertical line within the card body, male member tab being sufficiently flexible during the interconnection process to slide into a female member hole and snap into place, becoming seated together with a second snap-fit joint card body, resulting in a plurality of apparatuses.

### CROSS-REFERENCE TO RELATED APPLICATIONS

This application is related to, and claims the benefit of priority from, U.S. Provisional Patent Application Ser. No. 63/443,438, filed on Feb. 5, 2023, the disclosure of which application is incorporated herein by reference in its entirety.

### FIELD OF THE INVENTION

The present invention pertains to snap-fit joints for monolithic card elements, as well as collapsible easel apparatuses formed with such joints for holding and displaying objects including smartphones, digital tablets, greeting cards, books and calendars in a generally upright position on a support surface. More specifically to such snap-fit joints as are each characterized by a slot, a male member tab protruding from a wall within a slot, and a correspondingly spaced female member hole separate from the slot along the same vertical line within the card body element, the male member being resiliently flexible for temporary deformation during insertion into the female member hole.

### BACKGROUND

Various types of joints and snap-fit joints are known for interconnecting two or more separate parts. Cell phones also known as mobile phones, electronic communication devices, digital tablets are collectively described herein as “smartphones”, are in widespread use in today's world. In normal usage, a smartphone user may store and carry the smartphone in a pocket or purse. In situations where the smartphone user takes a break such as at a coffee shop, restaurant, or airport lounge, the user may place their smartphone on a table or other support surface which may not be completely clean.

In the post-Covid era, average consumers are more aware of the fact that unhealthy bacteria or viruses can be spread very easily. The majority of people carry a smartphone with them at all times. When a person visits a restaurant or coffee shop they will commonly lay their smartphone on the table. These tables can contain bacteria or virus microbes on the table surfaces and potentially transfer to their smartphone. Having an easily accessible smartphone stand, one that can be stored in a pocket, purse or wallet, to keep a smartphone off the table to a sufficient degree and that minimizes contact of the smartphone with the underlying table, would be more sanitary and help decrease the spread of germs, bacteria and viruses. However, consistently carrying a bulky smartphone stand or collapsible easel are all attended by various drawbacks and are not convenient options.

There is, accordingly, a need for a snap-fit joint to connect two or more card elements to create a portable smartphone stand that is at once simple in their manufacture and construction, yet characterized by acceptable strength and ease of portability.

### BRIEF SUMMARY OF INVENTION

The present invention comprehends a snap-fit joint for connecting at least first and second monolithic card elements to create a plurality of configurations for holding objects, the snap-fit joint comprising each of at least one slot, at least one male member tab and at least one female member hole. The snap-fit joint card elements are generally in a rectangular shape and are flat monolithic card body elements. The snap-fit joints are located at one or both distal ends of the monolithic card body elements, some of which can have various contouring cutouts for said objects to be placed upon. Smartphone stand configurations are made of two or more interconnecting snap-fit joint card elements, the first snap-fit joint card element, consisting of a slot in either an upwards or downwards orientation, at least one male member tab protruding from either side of the inner wall of the slot depending on the embodiment, and at least one female member hole separated from the slot along the same vertical line within the monolithic card element. The second snap-fit joint card element, consisting of a slot in either an upwards or downwards orientation, at least one male member tab protruding from either side of the inner wall of the slot depending on the embodiment, and at least one female member hole separated from the slot along the same vertical line within the monolithic card element.

In one embodiment the method of construction consists of aligning a vertically downward positioned snap-fit joint card element and the second snap-fit joint card element having a vertically upward orientation. Snap-fit card elements are joined by aligning the slot portion of the first snap-fit joint card with the slot portion of the second snap-fit joint card, causing interconnection by sliding the snap-fit joints together which engages the interlocking to begin, whereby each male member tab, sliding towards the female member hole, deforms sufficiently to reach the female member hole of the opposing snap-fit joint card element, whereby each male member tab snaps back into place, becoming seated within each female member hole and holds the configuration together.

The snap-fit joint allows the monolithic card elements to be interconnected so that they stand perpendicular to the horizontal support surface upon which they are placed, thereby offering rigid strength and horizontal adjustability of each of the monolithic snap-fit joint card element contoured cutout elements to hold the said object securely. The monolithic snap-fit joint card elements envisioned in the present invention may consist of flexible material including, but not limited to, plastic, PVC, PLA, composite plastic/paper material, bio-plastic, paper, paper-board, metal, metal/plastic composite and other elastic, thin materials.

In one embodiment of the invention two snap-fit joint card elements are interconnected with monolithic snap-fit joints with contouring cutouts specifically designed to hold an object, such as a smartphone, in two positions, in a vertical or horizontal orientation.

One embodiment of the invention includes three monolithic snap-fit joint card elements. Two card elements with snap-fit joints both in a vertically downward direction and contouring cutouts specifically designed to hold the object in two positions, vertical and horizontal. The third card element represents the back brace snap-fit card body with two vertically upward facing snap fit joints. The method of attachment is to connect the two snap-fit card elements with contouring cutouts by pushing each slot section in a downward motion into the back brace card element which has two corresponding snap-fit joints represented by upward oriented slots. This creates a configuration in which the horizontal width of the contoured cutouts can be freely adjusted to fit the desired object being placed in the easel or smartphone stand.

One embodiment of the invention has a snap-fit joint on each of both distal ends of a monolithic card element with each snap-fit joint facing in the opposite direction, one in an vertically upward orientation and one in a vertically downward orientation. This dual ended snap-fit joint embodiment provides for numerous snap-fit joint card elements to be interconnected to create a plurality of configurations.

One embodiment of the invention envisions monolithic card elements with a snap-fit joint containing two male member tabs facing in opposite directions within the slot and has two female member hole elements that are spaced separate from the slot in the same vertical line to correspond to the interlocking male member tab members.

In another embodiment, information about products and/or services of a business proprietor, or other service or product provider can be provided on the monolithic snap-fit joint card elements.

In another embodiment, at least one of a logo and an image can be provided on the monolithic snap-fit joint card elements, including advertising graphics and may include mechanically cutting certain card elements to a custom shape to complement the desired artwork.

These and other features, and advantages of the present invention will become more readily apparent from the attached drawings and the detailed description of the preferred embodiments, which follow.

### BRIEF DESCRIPTION OF DRAWINGS

FIG. 1 is a plan view of a monolithic snap-fit joint card body element with a vertically upward facing snap-fit joint element and contoured cutouts;

FIG. 2 is a plan view of a monolithic snap-fit joint card body element with vertically downward facing snap-fit joint element and contoured cutouts;

FIG. 3 shows the method of assembly for two monolithic snap-fit joint card bodies into a assembled configuration with contoured cutouts;

FIG. 4 shows an isometric view of an assembled two card body snap-fit joint card smartphone stand with interlocked snap-fit joints and contoured cutouts;

FIG. 5 shows an isometric view of an assembled two snap-fit card body configuration with interlocked snap-fit joints with contoured cutouts supporting a smartphone in a protective case in (a) a horizontal orientation and (b) a vertical orientation;

FIG. 6 shows a side elevation view of an assembled two snap-fit card body interlocked snap-fit joint configuration smartphone stand with contoured cutouts illustrated in FIG. 4;

FIG. 7 is a top view of an assembled two snap-fit card body interlocked snap-fit joint configuration smartphone stand illustrated in FIG. 4;

FIG. 8 is a rear elevation view of the assembled two snap-fit card body interlocked snap-fit joint configuration smartphone stand illustrated in FIG. 4;

FIG. 9. is a schematic plan view of one embodiment of the Applicant's three card back brace snap-fit joint configuration smartphone stand, with it's parts in orientation of it assembled form;

FIG. 10 is an isometric view of the assembled back brace three card snap-fit joint smartphone stand embodiment;

FIG. 11 is a plan view of a monolithic dual end snap-fit joint card with an upward facing snap-fit joint element on one distal end and a downward facing snap-fit joint element on the other distal end;

FIG. 12 is an isometric view of one embodiment of an assembled dual end snap-fit joint card configuration providing three interconnected dual end snap-fit joint card body elements;

FIG. 13 is a schematic plan view of one embodiment of a double snap-fit joint providing a double male member tab and a double female member hole snap-fit joint card embodiment with contoured cutouts, with it's parts in orientation of it assembled form;

FIG. 14 is an isometric view of an assembled double snap-fit joint smartphone stand embodiment.

### DETAILED DESCRIPTION OF THE INVENTION

The inventor provides a unique snap-fit joint system for card elements to create a plurality of useful and portable embodiments to hold objects, such as a smartphone. The present invention is described in enabling detail in the following examples, which may represent more than one embodiment of the present invention.

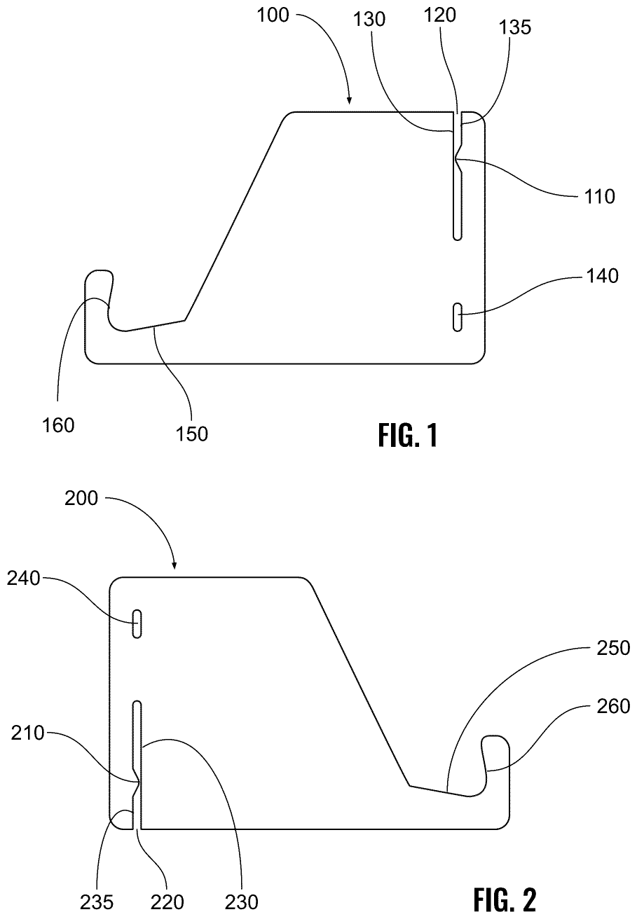

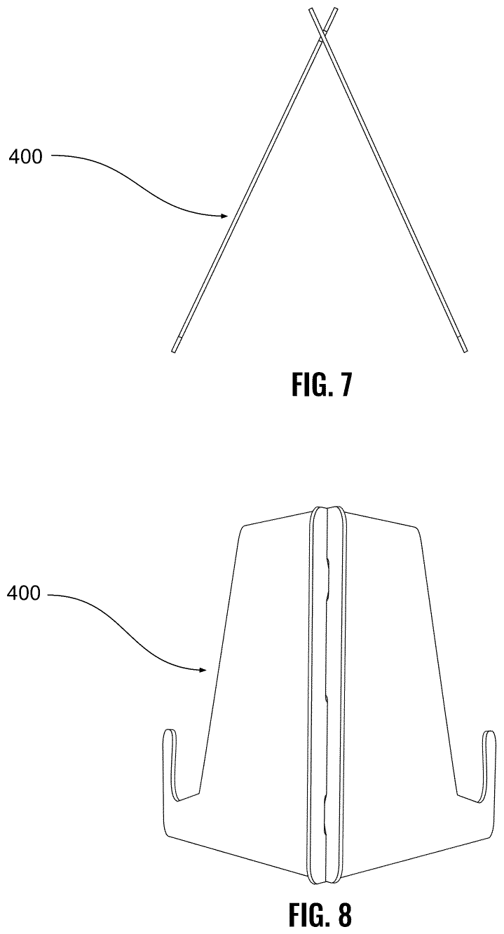

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upwards”, “downwards”, “left”, “right”, “front”, “back”, “rear”, “vertical”, “horizontal”, and derivatives thereof shall relate to the invention as oriented in FIGS. 1-14. Furthermore, there is no intention to be bound by any expressed or implied theory presented in the preceding technical field, background, brief summary of the following detailed description. It is also to be understood that the specific embodiments illustrated in the attached drawings, and described in the following specification, are simply exemplary embodiments of the inventive concepts defined in the claims. Hence, specific dimensions and other physical characteristics relating to the embodiments disclosed herein are not to be considered as limiting.

The accompanying drawings are not necessarily to scale, and some features may be exaggerated or minimized to show details of particular components.

Referring now to the drawings, wherein like numerals refer to like or corresponding parts throughout the several views, the present invention is generally characterized as a snap-fit joint for connecting at least first and second card body elements.

Shown throughout the figures, the present invention is directed toward a snap-fit joint for card elements to be assembled into a plurality of configurations, including an smartphone stand, smartphone stand, which can be easily deployed and disassembled quickly and carried with a person, such as in a person's wallet, pocket, purse, briefcase or other daily belongings holder.

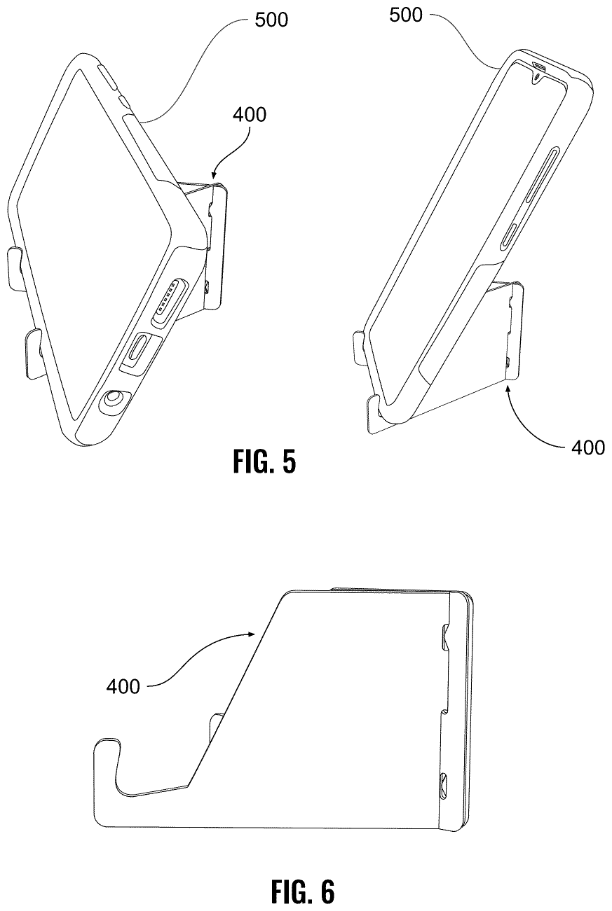

Referring initially to FIGS. 1 and 2, a first and second snap-fit joint for card elements is shown to create a smartphone stand 400 which can be customized with advertising graphics, and conveniently deployed as a smartphone stand to support a smartphone 500 (FIG. 5) is illustrated. The snap-fit joint for card elements for smartphone stand 400 includes a relatively thin and flat, rectangular shaped, flexible first snap-fit joint card body 100 and second snap-fit joint card body 200. In some embodiments, the card body 100 and 200 may be generally elongated and rectangular in shape, and may have the dimensions of a standard or conventional credit card. The card body 100 may optionally include one or more rounded corners and include contoured cutouts 150, a front brace 160 which are used for securing the user's smartphone in a variety of positions. The snap-fit card body 200 may optionally include one or more rounded corners and include contoured cutouts 250, a front brace 260 which are used for securing the user's smartphone in a variety of positions.

As illustrated in FIG. 1 the vertically upward oriented snap-fit joint for monolithic snap-fit joint card body 100 is located at the right distal end and consists of a male member tab 110 which is within a slot 120. Slot 120 has a left wall 130 and right wall 135. Male member tab 110 is located on right wall 135. Male member tab 110 protrudes from right wall 135 in a domed shape towards left wall 130 to narrow the space within slot 120 at this point. Aligned with slot 120 is a female member hole 140. Female member hole 140 is an elongated hole the same width as slot 120 located separate from slot 120 vertically down the card body. In a preferred embodiment snap-fit card body 100 may be made of sufficiently flexible, thin material such as plastic, PVC, PLA, composite plastic/paper material, bio-plastic, paper, paper-board, metal, metal/plastic composite and other elastic, thin materials and mechanically cut flat.

As illustrated in FIG. 2 the vertically downward oriented snap-fit joint for monolithic card body 200 is located at the left distal end and consists of a male member tab 210 which is within a slot 220. Slot 220 has a right wall 230 and left wall 235. Male member tab 210 is located on the left wall 235. Male member tab 210 protrudes from left wall 235 in a domed shape towards right wall 230 to narrow the space within slot 220 at this point. Aligned with slot 220 is a female member hole 240. Female member hole 240 is an elongated hole the same width as slot 220 located separate from slot 220 aligned vertically up the card body. In a preferred embodiment snap-fit card body 200 may be made of sufficiently flexible, thin material such as plastic, PVC, PLA, composite plastic/paper material, bio-plastic, paper, paper-board, metal, metal/plastic composite and other elastic, thin materials and mechanically cut flat.

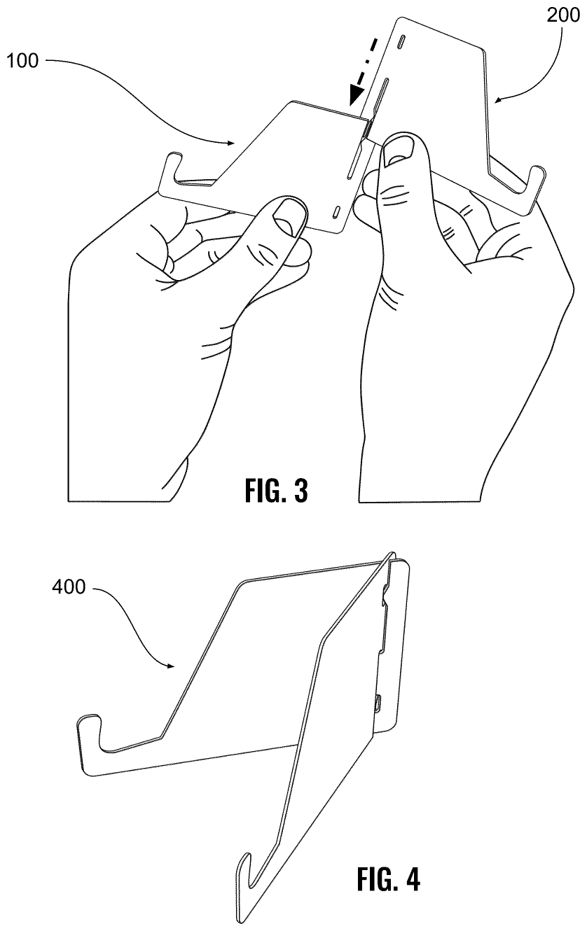

FIG. 3 illustrates how a user would assemble a snap-fit joint card body 100 and snap-fit joint card body 200 to create a smartphone stand configuration 400. The user will hold snap-fit joint card body 200 above snap-fit joint card body 100 and align slot 220 of snap-fit joint card body 200 with slot 120 of snap-fit joint card body 100. By causing downward pressure in pushing slot 220 of snap-fit joint card body 200 into slot 120 of snap-fit joint card body 100, male member tab 110 of snap-fit joint card body 100 and male member tab 210 of snap-fit joint card body 200 will begin to provide slight resistance and deform sufficiently until the male member tabs simultaneously reach correspondingly spaced female member hole 140 of snap-fit joint card body 100 and female member hole 240 of snap-fit joint card body 200 and snap into place, becoming seated. Smartphone stand 400 can be easily disassembled and stored in the users wallet or pocket.

FIG. 4 illustrates the created embodiment for smartphone stand 400. In a typical application the smartphone stand 400 may be deployed on a support surface (not illustrated) accommodating a smartphone 500 into the contoured cutouts 150 and 250 to be in a horizontal orientation or vertical orientation, supported by front brace 160 and 260.

Referring to FIGS. 5-8, the snap-fit joint card body 100 and snap-fit joint card body 200 can be assembled and be selectively deployed as smartphone stand 400. Smartphone stand 400 is deployed in a perpendicular orientation to the underlying support surface or table which creates vertical load strength supporting the weight of smartphone 500 and elevating smartphone 500 a safe distance off the underlying support surface so as to minimize bacteria or virus transfer from the support surface or table to the smartphone 500. The weight of smartphone 500 causes the snap-fit joint smartphone stand 400 to become more rigid and prevent it from swaying frontward and backward or side to side. Thus, in sleep or standby mode, the smartphone 500 can be readily accessed by the user in the event that the smartphone 500 receives a telephone call, text message or other notification. Alternatively, the user may be able to view videos or scroll through news articles displayed on smartphone 500 while it is in a snap-fit joint card smartphone stand 400.

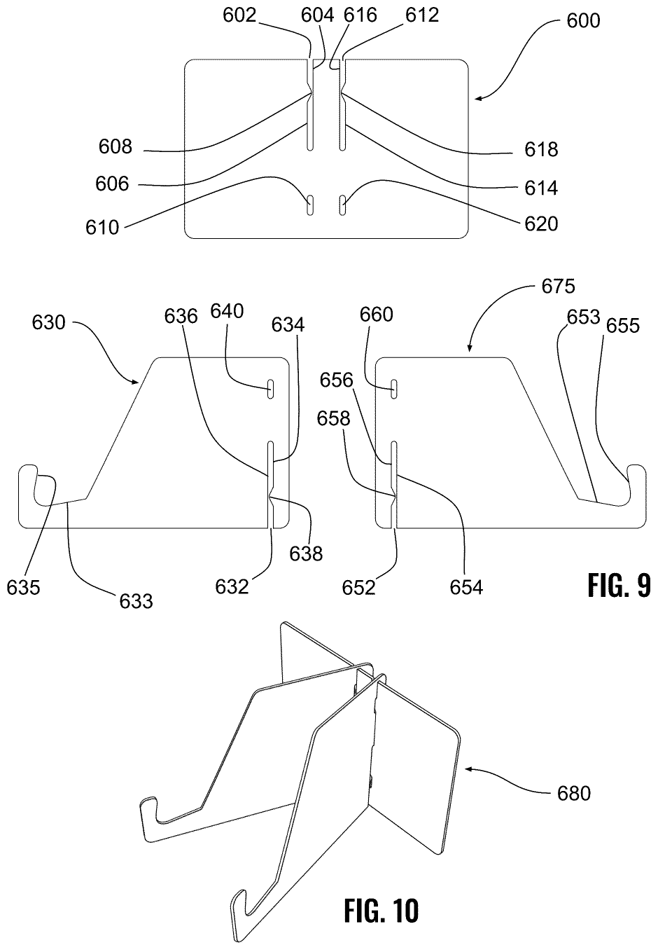

Referring to FIG. 10 in one embodiment a back brace snap-fit joint smartphone stand 680 is shown referencing FIG. 9 a snap-fit joint card body 630 and snap-fit joint card body 675 and snap-fit joint back brace card body 600. The back brace snap-fit joint smartphone stand 680 may be stored disassembled in a wallet or pocket. Snap-fit joint card body 675 shows a vertically downward snap-fit joint on the left distal end that is connected through a slot 652. Slot 652 has a right wall 654 and a left wall 656. Protruding from left wall 656 is a male member tab 658 in a domed shape towards inside wall 654 to narrow the space within slot 652 at this point. Aligned with slot 652 is a female member hole 660. Female member hole 660 is an elongated hole the same width as slot 652 located separate from slot 652 aligned vertically up the card body. Contoured cutouts 653 are shown which support a smartphone in a vertical position and horizontal position, a front brace 655 which are used for securing the smartphone 500 in a variety of positions.

Snap-fit joint card body 630 shows a vertically downward snap-fit joint on the right distal end that is connected through a slot 632. Slot 632 has a right wall 634 and a left wall 636. Protruding from right wall 634 is a male member tab 638 in a domed shape towards left wall 636 to narrow the space within slot 632 at this point. Aligned with slot 632 is a female hale 640. Female member hole 640 is an elongated hole the same width as slot 632 located separate from slot 632 aligned vertically up the card body. Contoured cutouts 633 are shown which support a smartphone in a vertical position and horizontal position, a front brace 635 which are used for securing the smartphone 500 in a variety of positions.

Referencing FIG. 9, in one embodiment of back brace snap-fit card body 600 has two vertically upward snap-fit joint segments off-center near the middle of the card body. The right upward oriented snap-fit joint has a slot 612. Slot 612 has a right wall 614 and a left wall 616. Protruding from right wall 614 is a male member tab 618 in a domed shape towards inside wall 616 to narrow the space within slot 612 at this point. Aligned with slot 612 is a female member hole 620. Female member hole 620 is an elongated hole the same width as slot 612 located separate from slot 612 aligned vertically down the card body. The left upward oriented snap-fit joint has a slot 602. Slot 602 has a right wall 604 and a left wall 606. Protruding from wall 606 is a male member tab 608 in a domed shape towards inside wall 604 to narrow the space within slot 602 at this point. Aligned with slot 602 is a female member hole 610. Female member hole 610 is an elongated hole the same width as slot 602 located separate from slot 602 aligned vertically down the card body. Back brace snap-fit joint card body 600 may include a custom mechanically cut shape and graphics including designs and company logos may be displayed on back brace 600 for purposes of advertising and personalization.

To connect snap-fit joint back brace card body 600 with snap-fit joint card body 630 and snap-fit joint card body 675 as shown in the assembled back brace smartphone stand 680 in FIG. 10, first, the vertically downward slot 632 of snap-fit joint card body 630 is aligned with a vertically upward snap-fit joint slot 602 of snap-fit joint card back brace card body 600. By causing downward pressure and pushing slot 632 into slot 602 male member tabs 608 and 638 will begin to provide slight resistance and deform sufficiently until the male member tabs simultaneously reach female member holes 610 and 640 and snap into place. Second, the vertically downward slot 652 of snap-fit joint card body 675 is aligned with a vertically upward snap-fit joint slot 612 of snap-fit joint card back brace card body 600. By causing downward pressure and pushing slot 652 into slot 612 male member tabs 618 and 658 will begin to provide slight resistance and deform sufficiently until the male member tabs simultaneously reach female member holes 620 and 660 and snap into place.

FIG. 10 shows the assembled back brace snap-fit joint smartphone stand 680 may then be placed on a support surface (not illustrated) and smartphone 500 can then be placed in the vertical or horizontal position in contoured cutouts 633 and 653 which are aligned and may be spaced apart freely horizontally to provide support for smartphone 500 which can be abutted to front brace 635 and 655.

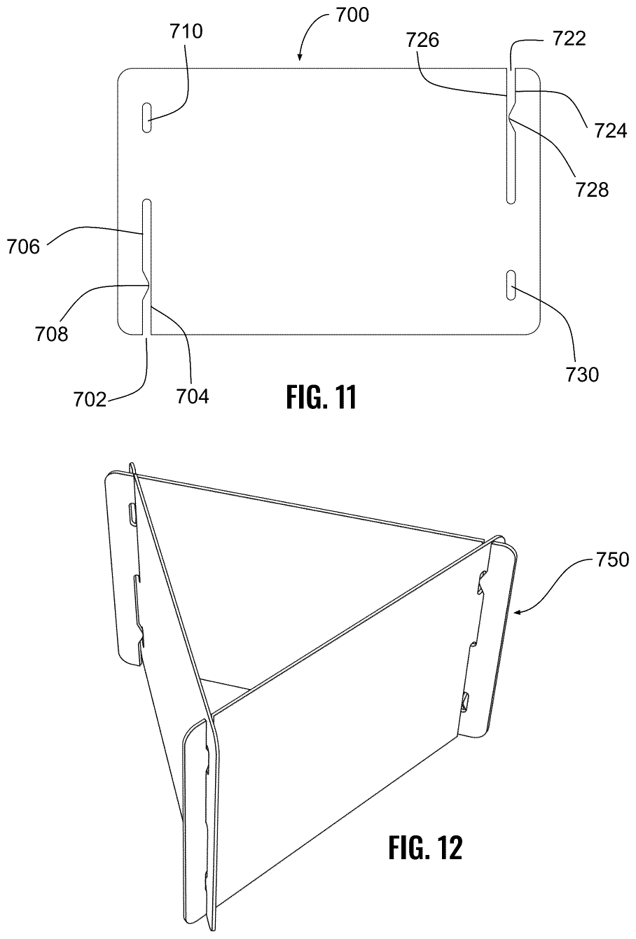

Referring to FIG. 12 in one embodiment of a three sided dual end snap-fit joint card configuration 750, a toy building element, created with multiple dual end snap-fit joint card body 700 elements shown in FIG. 11. Dual end snap-fit joint card body 700 has two opposite oriented snap-fit joint elements, one upward oriented snap-fit joint on the right distal end and one downward oriented snap-fit joint on the left distal end of card body 700.

First, dual end snap-fit joint card body 700 has a downwards oriented snap-fit joint on the distal left side of the card body that is connected through a slot 702. Slot 702 has a right wall 704 and a left wall 706. Protruding from left wall 706 is a male member tab 708 in a domed shape towards inside wall 704 to narrow the space within slot 702 at this point. Aligned with slot 702 is a female member hole 710. Female member hole 710 is an elongated hole the same width as slot 702 located separate from slot 702 aligned vertically up the card body.

On the opposite side, an upwards oriented snap-fit joint on the distal right side of the card body that is connected through a slot 722. Slot 722 has a right wall 724 and a left wall 726. Protruding from right wall 724 is a male member tab 728 in a domed shape towards inside wall 726 to narrow the space within slot 722 at this point. Aligned with slot 722 is a female member hole 730. Female member hole 730 is an elongated hole the same width as slot 722 located separate from slot 722 aligned vertically down the card body.

In one embodiment, to connect dual end snap-fit joint card body 700 elements as illustrated in a three sided dual end snap-fit joint configuration 750 in FIG. 12, a first snap-fit joint card body 700 with a vertically downward slot 702 is aligned with a second snap-fit joint card body 700 through slot 722. By causing downward pressure and pushing first snap-fit joint card body slot 702 into second snap-fit joint card body 700 slot 722 male member tabs 708 and 728 will begin to provide slight resistance and deform sufficiently until the male member tabs simultaneously reach female member holes 710 and 730 and snap into place. Multiple configurations can be created using this method of attachment. A configuration can be placed on a support surface or attached to a wall for three dimensional art. Additionally, graphics and logos can be included on dual end snap-fit card body 700 elements.

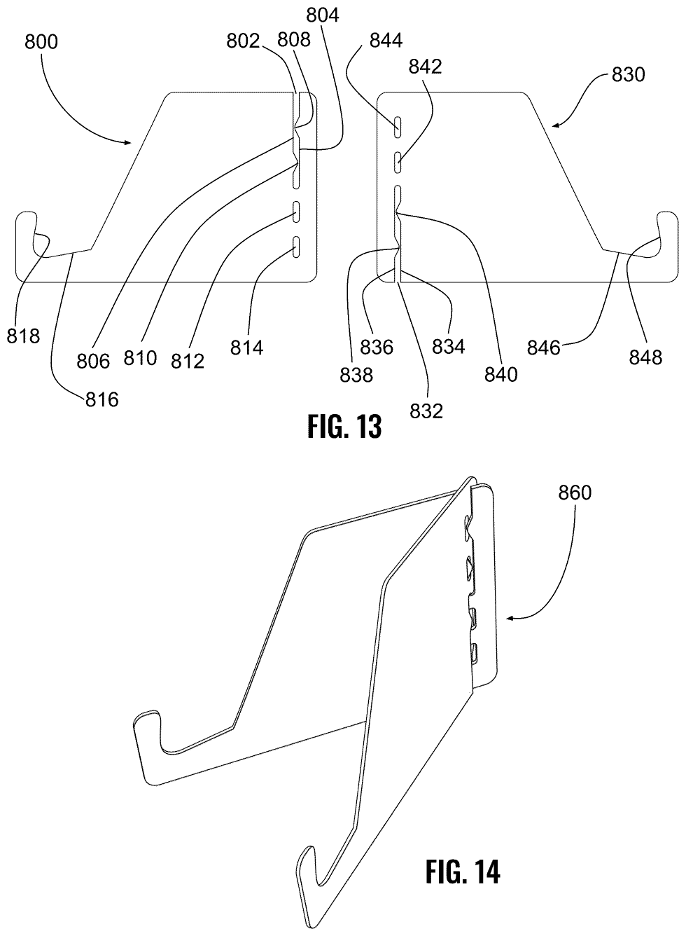

Referring initially to FIG. 13, double snap-fit joint for card elements to create smartphone stand 860 as shown in FIG. 14 which can be customized with advertising graphics, and conveniently deployed as a smartphone stand to support a smartphone 500 on a support surface (not illustrated). The double snap-fit joint for card elements for smartphone stand 860 includes a relatively thin and flat flexible first double snap-fit joint card body 800 and second double snap-fit joint card body 830. In some embodiments, the double snap-fit joint card body 800 and 830 may be generally elongated and rectangular in shape, and may have the dimensions of a standard or conventional credit card. The double snap-fit joint card body 800 may optionally include one or more rounded corners and include contoured cutouts 816, and front brace 818 which is used for securing a smartphone in a variety of positions. The double snap-fit joint card body 830 may optionally include one or more rounded corners and include contoured cutouts 846, and front brace 848 which are used for securing the user's smartphone in a variety of positions.

As illustrated in FIG. 13 the vertically upward oriented double snap-fit joint for monolithic double snap-fit joint card body 800 is located at the right distal end and consists of two male member tabs 808 and 810 which are within a slot 802. Slot 802 has a left wall 806 and right wall 804. Male member tab 808 is located on right wall 804 and male member tab 810 is located on left wall 806. Male member tab 808 protrudes from right wall 804 in a domed shape towards left wall 806 to narrow the space within slot 802 at this point. Further down within slot 802 is male member tab 810 which is located on left wall 806 and protrudes from left wall 806 in a domed shape towards right wall 804 to narrow the space within slot 802 at this point. Aligned with slot 802 are two female member holes 812 and 814. Female member hole 812 is an elongated hole the same width as slot 802 located separate from slot 802 aligned vertically down the card body. Further vertically down from female captivity 812 is female member hole 814. Female member hole 814 is an elongated hole the same width as slot 802 located separate from slot 802 aligned vertically down the card body near the distal bottom of the double snap-fit joint card body 800. In one embodiment contoured cutout 816 is shown and a front brace 818 which are used for securing the smartphone 500 in a variety of positions.

As illustrated in FIG. 13 the vertically downward oriented double snap-fit joint for monolithic double snap-fit joint card body 830 is located at the left distal end and consists of two male member tabs 838 and 840 which are within a slot 832. Slot 832 has a left wall 836 and right wall 834. Male member tab 838 is located on left wall 836 and male member tab 840 is located on right wall 834. Male member tab 838 protrudes from left wall 836 in a domed shape towards right wall 834 to narrow the space within slot 832 at this point. Further up within slot 832 is male member tab 840 which is located on right wall 834 and protrudes from right wall 834 in a domed shape towards left wall 836 to narrow the space within slot 832 at this point. Aligned with slot 832 are two female member holes 842 and 844. Female member hole 842 is an elongated hole the same width as slot 832 located separate from slot 832 aligned vertically up the card body. Further vertically up from female captivity 842 is female member hole 844. Female member hole 844 is an elongated hole the same width as slot 832 located separate from slot 832 aligned vertically up the card body near the distal top of the double snap-fit joint card body 830. In one embodiment contoured cutout 846 is shown and a front brace 848 which are used for securing the smartphone 500 in a variety of positions.

To connect double snap-fit joint card body 800 with double snap-fit joint joint card body 830 to complete assembled double snap-fit joint embodiment 860 as shown in FIG. 14. First, slot 832 of the vertically downward double snap-fit joint card body 830 is aligned with a vertically upward snap-fit joint slot 802 of double snap-fit joint card body 800. By causing downward pressure and pushing slot 832 into slot 802, male member tabs 808, 810, 838 and 840 will begin to provide slight resistance and deform sufficiently until all four male member tabs simultaneously reach female member holes 812, 814, 842 and 844 and snap into place.

FIG. 14 shows the assembled double snap-fit joint smartphone stand 860 which may then be placed on a support surface (not illustrated) and smartphone 500 can then be placed in a vertical or horizontal position of contoured cutouts 816 and 846 which are aligned and may be spaced apart freely horizontally to provide support for smartphone 500 which can be abutted to front brace 818 and 848.

In summary, the present invention provides for monolithic snap-fit joint card body elements for a smartphone accessory which solves the problem of providing a smartphone stand which keeps the device off the supporting surface, keeping the smartphone away from any bacteria or virus germs that may be on a table or supporting surface, is less bulky and much easier to carry and store than conventional smartphone stands. Furthermore, the snap-fit joint card smartphone stand can include text and/or graphics and be used as an advertising medium.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

The invention in which an exclusive property or privilege is claimed is defined as follows:

1. A monolithic snap-fit joint card body for connecting at least a first and second snap-fit joint card body members, a snap-fit joint card body comprising:
a card body with at least one of a vertically downward orientated slot; at least one of a vertically upward orientated slot; a slot having left and right walls on one or both distal ends for card body; at least one of a male member tab within slot protruding from at least one wall, being sufficiently flexible to deform during insertion into female member hole;
at least one of a female member hole separate from the slot along the same vertical line within the card body.

2. The monolithic snap-fit joint card body of claim 1, wherein the flexible card body is made of plastic, PVC, PLA, composite plastic/paper material, bio-plastic, paper, paper-board, metal, metal/plastic composite and other elastic, thin materials and mechanically cut.

3. The monolithic snap-fit joint card body of claim 1, wherein the male member tab is sufficiently flexible to snap into, becoming seated in the female member hole.

4. The monolithic snap-fit joint card body of claim 1, wherein the card body has contoured cutouts for placing a smartphone or an object in a plurality of positions, including vertically and horizontally.

5. A monolithic snap-fit joint card body of claim 1, wherein two or more snap-fit card bodies are interlocked by the snap-fit joint card elements.

6. A monolithic snap-fit joint card body of claim 1, wherein graphics including designs and company logos are displayed.

7. A monolithic snap-fit joint card body of claim 1, wherein the snap-fit joint card body is mechanically cut to a custom shape.

8. A snap-fit joint card smartphone stand comprising:
at least two interconnectable monolithic snap-fit joint card body elements comprising; a first card body with vertically downward orientated slot; a slot having left and right walls on one or both distal ends of card body; a male member tab within slot protruding from at least one wall, being sufficiently flexible to deform during insertion into female member hole, becoming seated; a female member hole separate from the slot along the same vertical line within card body; a second card body with vertically upward orientated slot; a slot having left and right walls on one or both distal ends of card body; a male member tab within slot protruding from at least one wall, being sufficiently flexible to deform during insertion into female member hole, becoming seated;
a female member hole separate from the slot along the same vertical line within card body;

9. The snap-fit joint card smartphone stand of claim 8, wherein the flexible card body is made of plastic, PVC, PLA, composite plastic/paper material, bio-plastic, paper, paper-board, metal, metal/plastic composite and other elastic, thin materials and mechanically cut.

10. The snap-fit joint card smartphone stand of claim 8, wherein the male member tab is sufficiently flexible to snap into, becoming seated in the female member hole.

11. The snap-fit joint card smartphone stand of claim 8, wherein the card body has contoured cutouts for placing a smartphone or an object in a plurality of positions.

12. The snap-fit joint card smartphone stand of claim 8, wherein three or more snap-fit card bodies are interlocked by the snap-fit joint card elements.

13. The snap-fit joint card smartphone stand of claim 8, wherein graphics including designs and company logos are displayed.

14. The snap-fit joint card smartphone stand of claim 8, wherein the snap-fit joint card body is mechanically cut to a custom shape.
